(19) United States
(12) Patent Application Publication
(10) Pub. No.: US 2010/0164608 A1
(43) Pub. Date: Jul. 1, 2010

(54) BANDGAP CIRCUIT AND TEMPERATURE SENSING CIRCUIT INCLUDING THE SAME

(76) Inventor: Yoon-Jae SHIN, Gyeonggi-do (KR)

Correspondence Address: IP & T Law Firm PLC, 7700 Little River Turnpike, Suite 207, Annandale, VA, 22003, US

(21) Appl. No.: 12/429,317

(22) Filed: Apr. 24, 2009

(30) Foreign Application Priority Data
Dec. 26, 2008 (KR) 10-2008-0134632

(51) Int. Cl. G05F 3/02

(52) U.S. Cl. 327/539

(57) ABSTRACT

A temperature sensing circuit includes a bandgap unit configured to output a temperature voltage varying according to a temperature and a reference voltage sustaining a predetermined level. A comparator is configured to compare the temperature voltage and the reference voltage and output temperature information.

### CROSS-REFERENCE TO RELATED APPLICATIONS

The present invention claims priority of Korean patent application number 10-2008-0134632, filed on Dec. 26, 2008, the disclosure of which is incorporated by reference herein in its entirety.

### BACKGROUND OF THE INVENTION

The present invention relates to a bandgap circuit and a temperature sensing circuit, and more particularly, to a technology of accurately sensing a temperature using a simple circuit.

Temperature is an important factor in a semiconductor device formed of integrated circuits. This is because basic constituent elements of the integrated circuit, such as a transistor, a resistor, and a capacitor, have characteristics varying according to a temperature. Accordingly, semiconductor devices internally include a temperature sensing circuit.

Hereinafter, a temperature sensing circuit in a semiconductor device such as a dynamic random access memory (DRAM) will be described. A DRAM cell includes a transistor functioning as a switch and a capacitor for storing charge (data). A state of data such as ‘high’ or ‘low’ is identified according to whether the capacitor in the memory cell stores charge or not, that is, according to whether a terminal voltage of the capacitor is high or low.

Since data is stored through accumulation of charge in the capacitor, the memory cell does not conceptually consume power. However, data may be erased because an initial charge amount of the capacitor may be lost due to leakage current generated by a PN connection of a MOS transistor. In order to prevent this, it is necessary to recharge the capacitor to have a normal charge amount according to information read from data stored in a memory cell before losing data.

Such operations cyclically repeat to maintain data stored in memory cells. A set of these operations for recharging a cell is referred to as a refresh operation. Due to the refresh operation, a DRAM consumes refresh power. The consumption of refresh power has become a critical issue in a battery-operated system that requires low power consumption because it is important to reduce power consumption in the battery-operated system.

One of methods to reduce power consumption for the refresh operation is changing a refresh cycle according to temperature. A data holding time in a DRAM becomes longer as the temperature becomes low. Therefore, it is possible to reduce power consumption by lowering a frequency of a refresh clock in a low temperature region after dividing a temperature region into a plurality of temperature regions. Thus, it is necessary to have a temperature sensing circuit for accurately sensing a temperature inside a DRAM and outputting the sensed temperature information.

A DRAM generates more heat as an integration level and an operation speed increase. The generated heat increases the internal temperature of the DRAM and disturbs a normal operation thereof. Sometimes, the generated heat causes defect in the DRAM. Therefore, it is required to have a temperature sensing circuit for accurately sensing a temperature of the DRAM and outputting the sensed temperature information.

It is also important to accurately measure a temperature even in a phase-charge random access memory (PCRAM) as well as the DRAM. This is because read characteristics need to be improved by changing a reference voltage of a sense amp according to the variation of reset resistance based on a temperature of the PCRAM.

As described above, various types of semiconductor devices require a temperature sensing circuit for accurately sensing a temperature of a semiconductor device.

### SUMMARY OF THE INVENTION

Embodiments of the present invention are directed to providing a temperature sensing circuit having a simple structure and accurately sensing a temperature.

In accordance with an aspect of the present invention, there is provided a temperature sensing circuit including a bandgap unit for outputting a temperature voltage varying according to a temperature and a reference voltage sustaining a predetermined level, and a comparator for comparing the temperature voltage and the reference voltage and outputting temperature information.

In accordance with another aspect of the present invention, there is provided a bandgap circuit including a current generator for generating temperature current varying in an amount of current according to a temperature, a temperature voltage generator for mirroring the temperature current and generating a temperature voltage by voltage drop caused by the mirrored current, and a reference voltage generator for mirroring the temperature current and generating a reference voltage based on voltage drop caused by the mirror current and sum of emitter-base voltage of a first transistor.

### BRIEF DESCRIPTION OF THE DRAWINGS

FIG. 1 is a diagram illustrating a temperature sensing circuit in accordance with an embodiment of the present invention.

FIG. 2 is a diagram illustrating a bandgap unit 110 of FIG. 1.

FIG. 3 is a diagram illustrating a comparator 120 of FIG. 1.

FIG. 4 is a graph describing operation of a temperature sensing circuit in accordance with an embodiment of the present invention.

### DESCRIPTION OF SPECIFIC EMBODIMENTS

Other objects and advantages of the present invention can be understood by the following description, and become apparent with reference to the embodiments of the present invention.

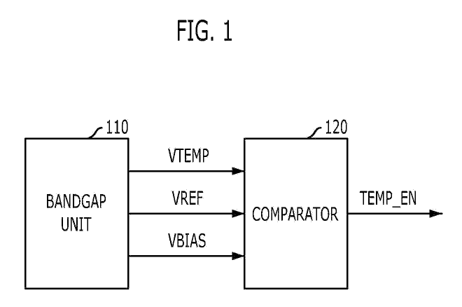

FIG. 1 is a diagram illustrating a temperature sensing circuit in accordance with an embodiment of the present invention.

As shown in FIG. 1, the temperature sensing circuit according to the present embodiment includes a bandgap unit 110 for outputting a temperature voltage VTEMP varying according to a temperature and a reference voltage VREF sustaining at a predetermined level. The bandgap unit 110 also includes a comparator 120 for comparing the temperature voltage VTEMP and the reference voltage VREF and outputting temperature information TEMP_EN.

The bandgap unit 110 generates a temperature voltage VTEMP that varies according to a temperature and a reference voltage VREF that sustains a predetermined level although a process, a voltage, and a temperature (PVT) are changed. The bandgap unit 110 may further generate a bias voltage VBIAS as a bias voltage of the comparator 120. The bias voltage VBIAS sustains at a predetermined level although the PVT is changed because the bias voltage VBIAS is generated by dividing the reference voltage VREF.

The comparator 120 compares the temperature voltage VTEMP with the reference voltage VREF and outputs temperature information TEMP_EN based on the comparison result. If the temperature voltage VTEP is higher than the reference voltage VREF, the temperature information TEMP_EN is enabled and outputted. If the reference voltage VREF is higher than the temperature voltage, the temperature information TEMP_EN is disabled. However, the present invention is not limited thereto. For example, when the reference voltage VREF is higher than the temperature voltage VTEMP, the temperature information TEMP_EN may be enabled and outputted.

The comparator 120 may use the bias voltage VBIAS generated by the bandgap unit 110 as a bias voltage thereof. When the comparator 120 uses the bias voltage VBIAS from the bandgap unit 110, it is possible to constantly control the amount of current flowing into the comparator 120. Therefore, the characteristics of the comparator 120 may be improved.

Although the temperature sensing circuit according to the present embodiment includes one comparator 120, the present invention is not limited thereto. A temperature sensing circuit according to another embodiment may include a plurality of comparators for comparing a temperature voltage with reference voltages having different levels. In this case, the temperature sensing circuit may output further accurate temperature information. For example, a temperature range is divided into two sub temperature ranges because the temperature sensing circuit according to the present embodiment includes only one comparator. However, if a temperature sensing circuit according to another embodiment includes three comparators, it is possible to divide a temperature range into four sub temperature ranges using temperature information enabled in different temperatures.

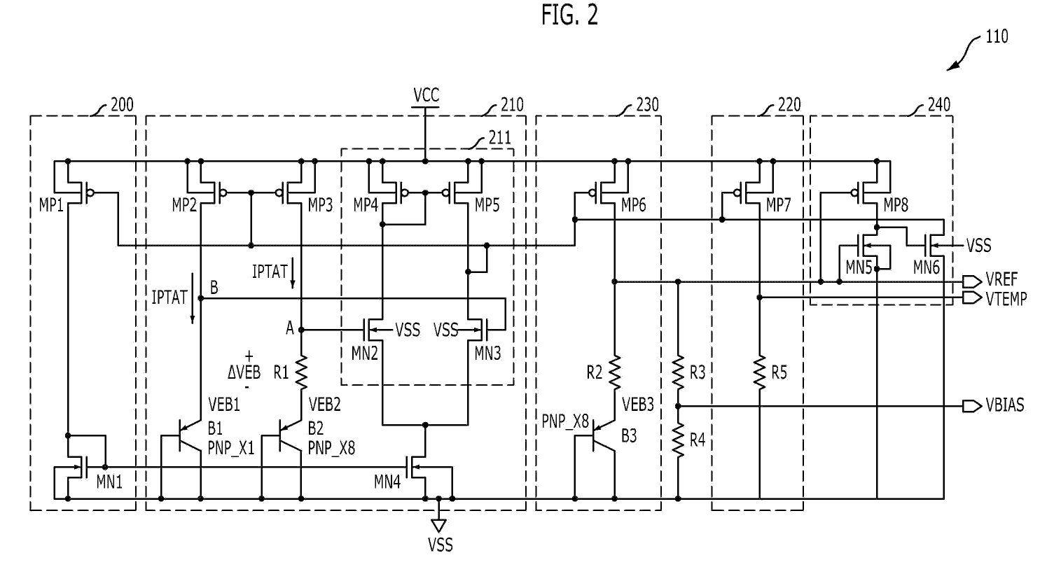

FIG. 2 is a diagram illustrating a bandgap unit 110 of FIG. 1. Referring to FIG. 2, the bandgap unit 110 includes a current generator 210, a temperature generator 220, and a reference voltage generator 230. The current generator generates a temperate current IPTAT that has a current amount varying according to a temperature. The temperature voltage generator 220 mirrors the temperature current IPTAT and generates a temperature voltage VTEMP based on a voltage drop caused by the mirrored current IPTAT. The reference voltage generator 230 mirrors the temperature current IPTAT and generates a reference voltage VREF based on sum of an emitter-base voltage VEB3 and a voltage drop caused by the mirrored current. The bandgap unit 110 may further include a current limiting unit 240 configured to make current amount flowing through the bandgap unit 110 at an initial stage and limiting current flowing into the bandgap unit 110 at a peak state.

The current generator 210 includes a second transistor B2, a resistor, a first transistor B1, a calculation amplifier 211, a third transistor MP3, and a second transistor MP2. The second transistor B2 includes a base and a collector, which are connected to the ground. The resistor is connected between an emitter of the second transistor B2 and a first node A. The first transistor includes a base and a collector, which are connected to the ground and an emitter connected to a second node B. The calculation amplifier 211 receives inputs through the first node A and the second node B. The third transistor supplies current to the first node A in response to the output of the calculation amplifier 211. The second transistor MP2 supplies current to the second node B in response to the output of the calculation amplifier 211.

The temperature voltage generator 220 includes a seventh transistor MP7 and a resistor R5. The seventh transistor MP7 supplies current to the temperature voltage generator 220 in response to the output of the calculation amplifier 211. The resistor R5 is connected between the seventh transistor MP7 and the ground end VSS and provides a temperature voltage VTEMP.

The reference voltage generator 230 includes a sixth transistor MP6, a resistor R2, and a third transistor B3. The sixth transistor MP6 supplies current to the reference voltage generator 230 in response to the output of the calculation amplifier 211. The resistor R2 is connected between the sixth transistor MP6 and the reference voltage output terminal VREF. The third transistor B3 includes a base and a collector, which are connected to the ground, and an emitter connected to the reference voltage output terminal VREF.

Hereinafter, operation of the bandgap circuit according to the present embodiment will be described in detail.

The current generator 210 generates a temperature current IPTAT that flows by an emitter-base voltage difference ΔVBE of two transistors B1 and B2. Due to a virtual short concept of the calculation amplifier 211, the voltage of the first node becomes equal to that of the second node, and an amount of current flowing through two transistors MP2 and MP3 are the same. Therefore, the relation can be expressed as Eq. 1.

$$Δ VEB = VEB 1 - VEB 2 = \frac{kT}{q} ln ( \frac{J 1}{J 2} ) \qquad Eq . 1$$

In Eq. 1, k denotes a Boltzmann's constant, q denotes quantity of electric charge, and T denotes an absolute temperature. J1 and J2 denote current density of a forward biased diode.

Since the temperature current IPTAT becomes current flowing to the resistor R1 by the emitter-base voltage difference ΔVBE, the temperature current can be expressed as Eq. 2.

$$IPTAT = Δ VBE / R 1 = \frac{kT}{qR 1} ln ( \frac{J 1}{J 2} ) \qquad Eq . 2$$

Therefore, the temperature current IPTAT becomes current having amplitude decided in proportion to a temperature.

The seventh transistor MP7 of the temperature voltage generator 220 receives an output voltage of the calculation amplifier through a gate like the third transistor MP3. Therefore, the current flowing through the seventh transistor MP7 becomes equal to the current flowing through the third transistor MP3. That is, the seventh transistor MP7 mirrors the temperature current IPTAT and flows it into the resistor R5. Therefore, the temperature voltage VTEMP becomes VTEMP=IPTAT*R5 and it can be expressed as Eq. 3.

$$VTEMP = IPTAT * R 5 = \frac{kR 5 * T}{qR 1} ln ( \frac{J 1}{J 2} ) \qquad Eq . 3$$

That is, a temperature voltage VTEMP becomes voltage having a level that increases in proportion to a temperature.

The sixth transistor MP6 of the reference voltage generator 230 receives the output voltage of the calculation amplifier 211 through a gate thereof like the third transistor MP3. Therefore, the current flowing into the sixth transistor MP6 becomes equal to the current flowing into the third transistor MP3. That is, the sixth transistor MP6 mirrors a temperature current and the temperature current flows into the reference voltage output terminal VREF. If the resistors R3 and R4 are not included (if the bandgap unit does not generate the bias voltage VBIAS), the temperature current only flows into the resistor R2 and the voltage drop caused by the resistor R2 becomes IRTAT*R2. The reference voltage can be expressed as Eq. 4 because the reference voltage is equal to the sum of the voltage drop caused by the resistor R2 and the emitter-base voltage VEB3 of the third transistor B3.

VREF=R2*IPTAT+VEB3 Eq. 4

Here, the temperature current IPTAT is a value increasing according to a temperature, and the emitter-base voltage VEB3 is a value decreasing according to a temperature. Therefore, it is possible to constantly sustain the reference voltage VREF at a predetermined level regardless of the temperature.

If the resistors R3 and R4 are included (if the bandgap unit generates the bias voltage VBIAS), the temperature current IPTAT is divided and flows into the resistor R2 and the resistors R3 and R4. Therefore, the reference voltage VREF can be expressed as Eq. 5.

$$VREF = \frac{( R 3 + R 4 )}{R 2 + ( R 3 + R 4 )} ( VEB 3 + IPTAT * R 2 ) \qquad Eq . 5$$

In this case, it is possible to make the reference voltage VREF to have a constant level regardless of a temperature by properly controlling a value of the resistor R2.

The bias voltage VBIAS is generated by dividing the reference voltage VREF. The bias voltage VBIAS can be expressed as Eq. 6.

$$VBIAS = \frac{VREF * R 4}{R 3 + R 4} \qquad Eq . 6$$

That is, the bias voltage VBIAS becomes a voltage having a predetermined level constantly sustained regardless of a temperature like the reference voltage VREF.

The current limiting unit 240 is a start-up circuit of the bandgap unit. If an eighth transistor MP8 is turned on because a reference voltage is low at an initial stage, a gate voltage of a sixth transistor MN6 increases and a voltage level of the calculation amplifier output terminal 211 is lowered, thereby making the bandgap unit to start operating. Then, when the level of the reference voltage VREF increases and reaches a peak state, the reference voltage VREF turns off the eighth transistor MP8, thereby increasing the level of the output terminal of the calculation amplifier 211. Thus, the first transistor MP1 is turned off, and the amount of current flowing into the bandgap unit 110 decreases by reducing a voltage inputted to a gate of the bias transistor MN4 of the calculation amplifier 211.

That is, the current limiting unit 240 makes the band gap unit 110 start an initial operation and reduces an amount of standby current by reducing power consumption of the bandgap unit 110 when output voltages VREF, VTEMP, and VBIAS of the bandgap unit 110 reach the peak state.

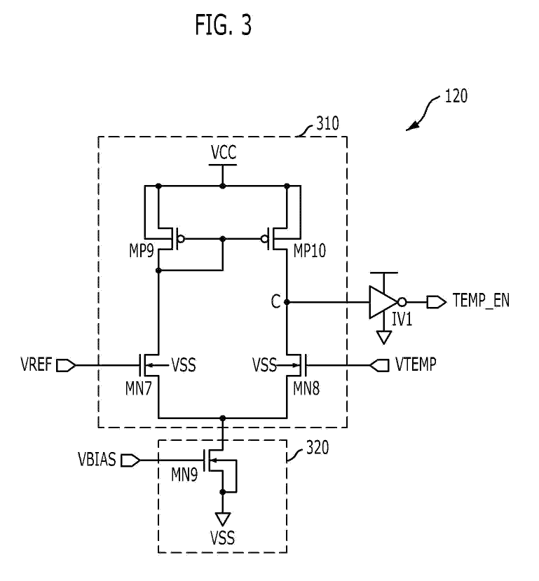

FIG. 3 is a diagram illustrating a comparator 120 of FIG. 1. As shown in FIG. 3, the comparator 120 includes a differential amplifier 310 and a current amount controller 320. The differential amplifier 310 includes transistors MP9, MP10, MN7, and MN8. The differential amplifier 310 compares a temperature voltage VTEMP and a reference voltage VREF. The current amount controller 320 controls an amount of current flowing into the differential amplifier 310.

The current amount controller 320 is formed of a ninth transistor MN9 receiving a bias voltage VBIAS. The bias voltage VBIAS constantly sustains a predetermined level regardless of the variation of PVT. Therefore, the current controller 320 controls an amount of current flowing into the differential amplifier 310 to be constantly sustained. Therefore, the differential amplifier 310 can sustain excellent performance.

The differential amplifier 310 compares a temperature voltage VTEMP and a reference voltage VREF with each other. If the temperature voltage VTEMP is higher than a reference voltage VREF, a logical level of a node C becomes ‘low’. Then, an inverter IV1 inverts it and outputs ‘high’ level temperature information TEMP_EN. If the reference voltage VREF is higher than the temperature voltage VTEMP, the logical level of the node C becomes ‘high’ and the inverter IV1 inverts it and outputs ‘low’ level temperature information TEMP_EN.

Therefore, the temperature information TEMP_EN becomes information indicating whether a current temperature is lower or higher than a predetermined temperature. The predetermined temperature, as a reference temperature for enabling or disabling temperature information TEMP_EN, can be controlled by changing a level of the reference voltage VREF.

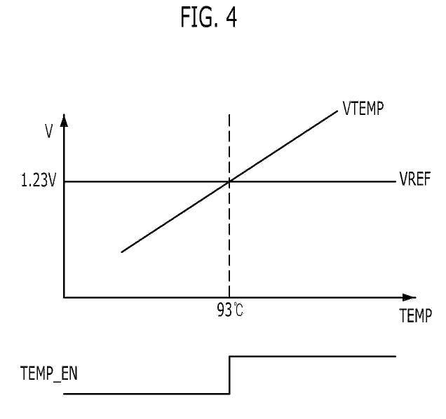

FIG. 4 is a graph for describing operation of a temperature sensing circuit in accordance with an embodiment of the present invention.

The reference voltage VREF always sustains a predetermined level although a temperature is changed. The temperature voltage VTEMP varies in proportion to a temperature. If the temperature voltage VTEMP becomes higher than the reference voltage VREF due to increment of the temperature, such as 92° C., the temperature information TEMP_EN0 is enabled to ‘high’.

That is, the temperature information TEMP_EN becomes information indicating whether a current temperature is higher than a predetermined temperature such as 92° C.

The present invention relates to a temperature sensing circuit. The temperature sensing circuit according to the present invention generates temperature information using a method for comparing a temperature voltage varying according to a temperature and a reference voltage sustaining a predetermined level constantly although PVT is changed, which are outputted from a bandgap circuit. Therefore, it is possible to generate accurate temperature information constantly.

Also, the bandgap circuit according to the present invention may advantageously have a simple circuit and generates accurate temperature voltage and reference voltage.

While the present invention has been described with respect to the specific embodiments, it will be apparent to those skilled in the art that various changes and modifications may be made without departing from the spirit and scope of the invention as defined in the following claims.

What is claimed is:

1. A temperature sensing circuit, comprising:
a bandgap unit configured to output a temperature voltage varying according to a temperature and a reference voltage sustaining a predetermined level; and
a comparator configured to compare the temperature voltage outputted from the bandgap unit with the reference voltage and to output temperature information.

2. The temperature sensing circuit of claim 1, wherein the bandgap unit generates a bias voltage that constantly sustains a predetermined level.

3. The temperature sensing circuit of claim 2, wherein the comparator includes:
a differential amplifier configured to compare the temperature voltage with the reference voltage; and
a current amount controller configured to control an amount of current flowing into the differential amplifier in response to the bias voltage.

4. The temperature sensing circuit of claim 1, wherein the bandgap unit includes:
a current generator configured to generate a temperature current varying in an amount of current according to the temperature;
a temperature voltage generator configured to mirror the temperature current and generating the temperature voltage based on voltage drop caused by the mirrored current; and
a reference voltage generator configured to mirror the temperature current and to generate the reference voltage based on sum of an emitter-base voltage of a first transistor and a voltage drop caused by the mirrored current.

5. The temperature sensing circuit of claim 4, wherein the current generator includes a second transistor and a third transistor, and
wherein the temperature current flows in response to a voltage difference between an emitter-base voltage of the second transistor and an emitter-base voltage of the third transistor.

6. A bandgap circuit, comprising:
a current generator configured to generate temperature current varying in an amount of current according to a temperature;
a temperature voltage generator configured to mirror the temperature current outputted from the current generator and to generate a temperature voltage based on a voltage drop caused by the mirrored current; and
a reference voltage generator configured to mirror the temperature current and to generate a reference voltage based on sum of an emitter-based voltage of a first transistor and a voltage drop caused by the mirror current.

7. The bandgap circuit of claim 6, wherein the current generator includes a second transistor and a third transistor, and
wherein the temperature current flows in response to a voltage difference between an emitter-base voltage of the second transistor and an emitter-base voltage of the third transistor.

8. The bandgap circuit of claim 6, wherein the current generator includes:
a second transistor having a base and a collector connected to a ground;
a resistor connected between an emitter of the second transistor and a first node;
a third transistor having a base and a collector connected to ground and an emitter connected to a second node;
a calculation amplifier configured to receive the first node and the second node as connected inputs;
a fourth transistor configured to supply current to the first node in response to output of the calculation amplifier; and
a fifth transistor configured to supply current to the second node in response to the output of the calculation amplifier.

9. The bandgap circuit of claim 8, wherein the temperature voltage generator includes:
a sixth transistor configured to supply current to the temperature voltage generator in response to the output of the calculation amplifier; and
a resistor connected between the sixth transistor and a ground end and supplying the temperature voltage.

10. The bandgap circuit of claim 9, wherein the reference voltage generator includes:
a seventh transistor configured to supply current to the reference voltage generator in response to the output of the calculation amplifier;
a resistor connected between the seventh transistor and a reference voltage output terminal; and
a third transistor having a base and a collector, and an emitter connected to the reference voltage output terminal.

11. The bandgap circuit of claim 8, wherein the bandgap circuit further includes a current limiting unit configured to cause current to flow into the bandgap circuit at an initial stage and limiting current flowing into the bandgap circuit at a peak stage.

12. The bandgap circuit of claim 7, wherein the second transistor and the third transistor are different in size.
